(19) United States
(12) Patent Application Publication
(10) Pub. No.: US 2015/0134464 A1
(43) Pub. Date: May 14, 2015

(54) ADVERTISEMENT INFORMATION AND BIDDING SYSTEM

(71) Applicant: VINDICO LLC, Irvine, CA (US)

(72) Inventors: Varoujan Bedirian, Los Angeles, CA (US); Adrian Piotr Witas, Los Angeles, CA (US)

(73) Assignee: VINDICO LLC, Irvine, CA (US)

(21) Appl. No.: 14/532,906

(22) Filed: Nov. 4, 2014

Related U.S. Application Data
(60) Provisional application No. 61/901,950, filed on Nov. 8, 2013.

(51) Int. Cl. G06Q 30/02

(52) U.S. Cl. CPC G06Q 30/0275
USPC 705/14.71

(57) ABSTRACT

A method, system, apparatus, advertising exchange system, and computer program product for acquiring advertisement impressions through an advertisement auction. A first maximum bid price to acquire an impression is defined. An entity set of one or more entities is identified. A second maximum bid price (that is higher than the first maximum price) to acquire the impression is defined. The first max bid price is used to bid for the impression during the advertisement auction. If the auction is being lost to the entity set, the bidding continues using the second maximum bid price.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/901,950, filed on Nov. 8, 2013, by Varoujan Bedirian and Adrian Piotr Witas, entitled “Advertisement information and Bidding System,” attorneys' docket number 257.77-US-P1.

This application is related to the following co-pending and commonly-assigned patent application, which application is incorporated by reference herein:

U.S. patent application Ser. No. 14/177,507, filed on Feb. 11, 2014 by Christophe L. Clapp and Brian C. DeFrancesco, entitled “SYSTEM AND METHOD TO ANALYZE AND RATE ONLINE ADVERTISEMENT PLACEMENT QUALITY AND POTENTIAL VALUE”, which application claims priority to U.S. Provisional Patent Application Ser. No. 61/763,236, filed on Feb. 11, 2013, by Christophe L. Clapp and Brian C. DeFrancesco, entitled “System and Methodology to Analyze and Rate Online Advertisement Placement Quality and Potential Value,” attorneys' docket number 257.74-US-P1; and

U.S. patent application Ser. No. 14/474,947, filed on Sep. 2, 2014, by Jason J. A. Knapp, Varoujan Bedirian, and Sergey Kuznetsov, entitled “BIDDING FOR ADVERTISING IMPRESSION IN AN ONLINE EXCHANGE USING ONE OR MORE MULTIPLE QUALITY MEASUREMENTS,” attorneys' docket number 257.78-US-U1, which application claims priority to Provisional Application Ser. No. 61/873,311, filed on Sep. 3, 2013, by Jason J. A. Knapp, Varoujan Bedirian, and Sergey Kuznetsov, entitled “BIDDING FOR ADVERTISING IMPRESSION IN AN ONLINE EXCHANGE USING ONE OR MORE MULTIPLE QUALITY MEASUREMENTS,” attorneys' docket number 257.78-US-P1.

### BACKGROUND OF THE INVENTION

1. Field of the Invention

The present invention relates generally to electronic/online advertisements, and in particular, to a method, apparatus, system, computer program product, and article of manufacture for providing information regarding advertisers and the neutralization in the marketplace of a competitor's advertisement campaign.

2. Description of the Related Art

Advertisers try to reach consumers using a variety of delivery mechanisms including via web-based advertising on the Internet and commercial broadcast advertising. Advertisements may be presented to potential consumers on a variety of presentation devices including televisions and/or portable devices [e.g., cellular devices, personal digital assistants, tablet computers, etc.]. In this regard and as used herein, an advertising impression is an individual instance when an advertisement (ad) is shown to a particular user. For example, when a user selects a web page to view, that instance of the web page may provide one or more opportunities for an ad impression (also referred to as an “impression”). If the user selects to view another web page, the other web page may provide one or more additional opportunities for an ad impression, i.e., another instance when an ad can be presented to the user.

Prior art mechanisms for advertisers to purchase an impression may award an impression to the highest bidder. Straight forward highest bidder based systems fail to provide a capability for an advertiser to develop and utilize a customized approach for securing advertising impressions. In this regard, in prior art systems, advertisers are required to establish a maximum bid and attempt to purchase impressions via a trial and error approach (i.e., if the bid fails, the advertiser increases the bid amount, and repeats the process until sufficient advertising impressions have been secured). However, prior art methods do not allow an advertiser to uniquely target another advertiser's inventory, nor uniquely monitor the purchases of another advertiser with the intention to outdo that competitor in terms of volume in the open market. Consequently, unless a guaranteed fix price is utilized, there is no method that guarantees (or increases the likelihood) that an advertiser will acquire impressions (i.e., other than bidding an increasingly higher amount based on trial and error) above and beyond its competition. In view of the above, it is desirable to provide to an advertiser a methodology/mechanism for securing ad impressions while also allowing that advertiser to provide some information regarding its unique competitive landscape. To better understand the problems of the prior art, a description of prior art advertisement technology may be useful.

Over the past few years, there has been a tremendous increase in display, video or audio ad inventory and demand, and the market has capitalized on the explosion of growth, by delivering different mechanisms of purchase to different needs. Primarily, advertisers can purchase in a fixed price, guaranteed volume basis. This is akin to a “Forward Market” instituted via Insertion Orders and executed at a future point in time. Alternatively, advertisers can purchase in a “Spot Market” where for each impression an auction takes place, possibly involving a number of 3^{rd} party ad servers in a bid request-bid response dyad to gather competitive bids and determine the party that values this impression the highest.

The second model for purchasing advertising (i.e., Spot Market) usually involves a second price auction to determine the closing price, and real time bidding mechanisms, where for every impression that arrives, a request for a bid for that advertisement is issued to one or more interested parties (e.g., a media purchasing entity, an advertisement firm, etc.). Such a bid request may provide information about the impression (e.g., the website, possible demographic information, etc.) and requests a bid. In response, bids are received and usually the highest bidder is awarded the impression. In such a Spot Market/real-time bidding auction, the name of the actual advertiser (distinct from the middleman that is attempting to purchase the advertisement impression) may be provided/required in a submitted bid. In other words, the programmatic buyer may submit bids on behalf of individual advertisers for advertisement space.

Regardless of the method/model used to acquire/place an advertisement, to develop an acceptable advertisement purchasing strategy, it is desirable for advertisers to ascertain information about the competitive landscape (e.g., information about who/what entity is bidding for the same advertisement impressions, the price being paid by competitors, etc.). Prior art mechanisms fail to provide sufficient information regarding the competitive/bidding landscape to potential advertisers and provide a limited ability to develop and utilize a customized approach for securing advertising space/impressions.

### SUMMARY OF THE INVENTION

Embodiments of the invention overcome the problems of the prior art by providing a user interface to define/specify bidding campaign parameters. In addition, a client may define a neutralizer campaign that enables a client to conquest impressions being sought after by a named set of competitors/category of competitors, possibly even at the level or grade of inventory quality.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the logical flow for an exemplary runtime execution of a neutralizer campaign in accordance with one or more embodiments of the invention; and

FIG. 4 illustrates a Venn-like diagram illustrating the target and total impressions for various clients in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

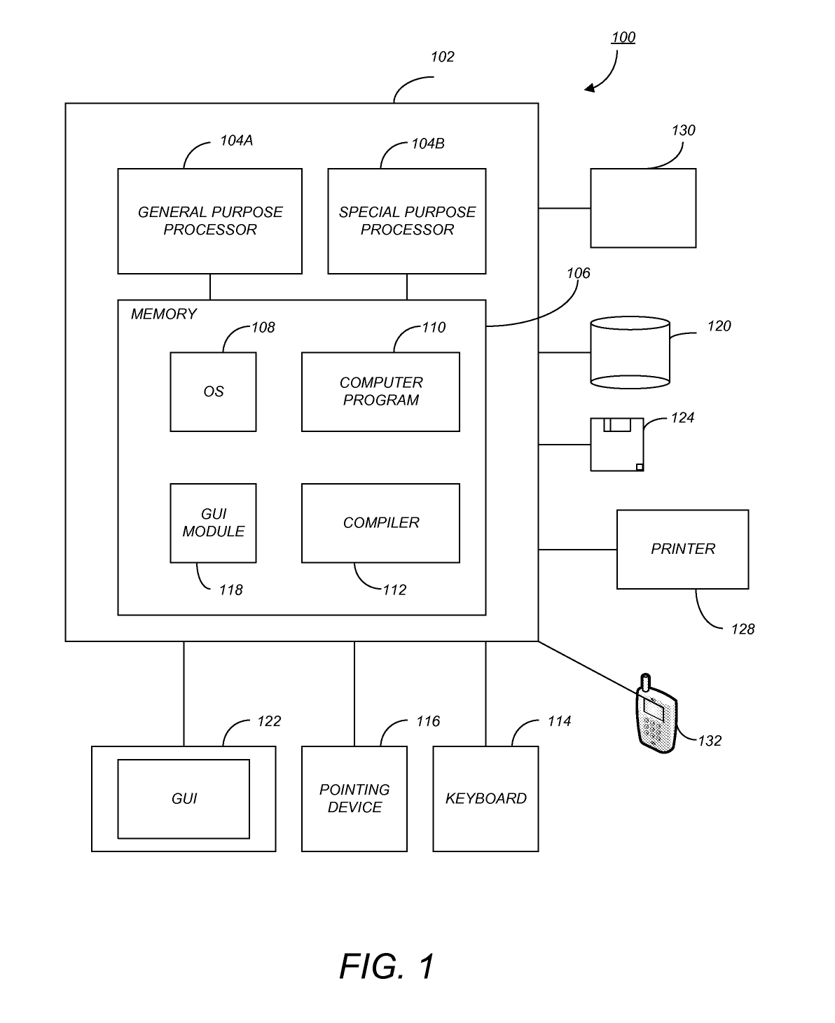

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display (and/or a LED-backlit LCD display) having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL (Common Business-Oriented Language), Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

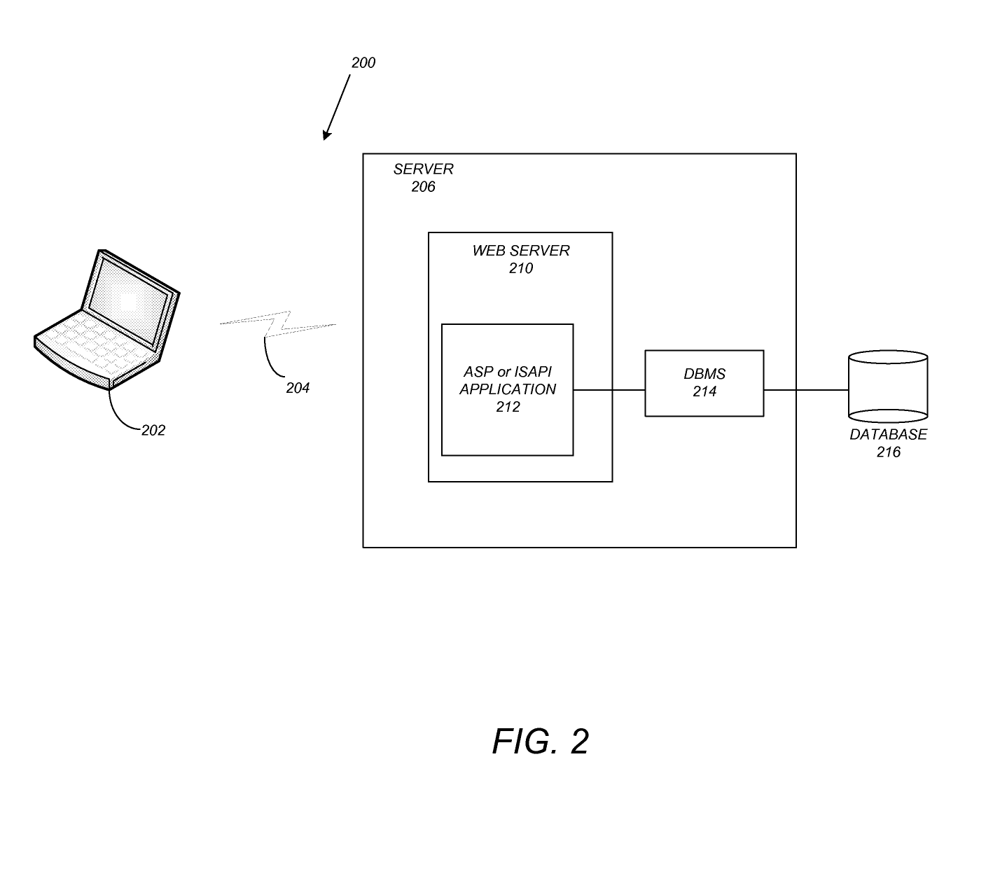

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT′S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### Software Embodiment Overview

Embodiments of the invention are implemented as a software application on a client 202 or server computer 206. Further, as described above, the client 202 or server computer 206 may comprise a thin client device or a portable device that has a multi-touch-based display.

Embodiments of the invention provide a self-service user interface (UI) used in combination with a second price auction. Such a UI may be provided to advertisement agencies and is used to configure a managed bidding service and place bids for advertisements (e.g., referred to as a bid manager order). For example, an advertising entity may configure a maximum bid, the number of impressions desired, the desired demographic, parameters, etc. into an advertisement bidding engine that will secure bids during a real-time second price auction. In such a system, different parameters (e.g., prices/maximums) may also be configured for different grades of inventory. An inventory grading system ranks or grades the advertisement impressions during a second price auction. As an example, if a web page has a single advertisement, it may be graded higher or as more valuable than a web page with ten advertisements. Similarly, if one large ad is on a web page, the large ad may be more valuable than a large number of smaller ads. In another example, if a single pixel has fifty (50) advertisements within it (so that none of the ads are actually visible) and/or if a single page has fifty (5) advertisements within it (so that the page has a large number of ads), the grading may be zero or a managed service may not accept bids for such an impression. Further, different vendors (i.e., domain name or domain name owner) may have different grades (e.g., Yahoo! ™ vs. National Enquirer™) Accordingly, buyers may have some knowledge base regarding what they are bidding on. Thus, such user interfaces may allow buyers to enter higher bids for higher quality inventory.

Accordingly, a software application provides an advertising exchange/bidding system with a UI component. Such a UI component may be part of a bid manager/bid management application. A user (e.g. an employee of an agency buying media on behalf of an advertiser) may enter configuration/advertising campaign information into the UI. Once entered, an ad campaign may be stored in a computer 100 (e.g., in database 120). An advertising campaign (also referred to as a bidding strategy) from one user may compete with an advertising campaign of a second/different user (e.g., competing for the same impression).

There may be two different types of bids within an ad server: Fixed price and 2^{nd} price auction. As of today, fixed price campaigns are entered internally via traffickers at an advertisement management entity (e.g., Specific Media™), and as for 2^{nd} price auctions, they are either campaigns entered via a bid manager (e.g., the Vindico™ Bid Manager), or are bids sent via real-time bidding request-response mechanisms for each bid.

Bidding Landscape Information

To enable a user to more accurately design an advertisement campaign, embodiments of the invention may provide mid- and post-campaign competitive bidding landscape information to a user/bidding entity (e.g., for a service fee, aggregated competitive landscape information is packaged towards the client/agency). Such information may be specific or may be in an aggregated form. Further, embodiments of the invention may categorize each Real-Time Bidding 3rd party ad server's/bidder's bid and each 1^{st} party campaign's bid (whether fixed price or working off of 2^{nd} price auction mechanism) into one or more industries/categories in order to provide relevant information to a requesting party/entity. Thus, provided information may include the name(s) of competing bidders (winners and/or losers, depending on whether contractually the system may expose that information), the industry/category of competing bidder(s) (winners and/or losers), aggregated pricing of won impressions across competitors, etc.

In an exemplary use case, suppose an agency is purchasing impressions on behalf of a specific client and has a budget of $1 million for a one month time period. The agency places, on behalf of a client, a maximum bid for the highest quality inventory (e.g., no more than $15 per bid/impression) and specifies that the sum of all closing prices should not be more than $1 million after the one month has expired. It may be noticed that by the 6^{th} and/or 7^{th} day, the million dollars has not been touched likely due to being overbid by another entity. In one or more embodiments of the invention, information may be provided (e.g., for a fee) to the losing agency. For example, information may include the reason why the agency is losing the bid (e.g., outbid by another entity). Alternatively, the name and/or category of the winning bidder may be provided (with or without corresponding percentages reflecting the loss of bids). In this regard, the information may consist of the following information regarding impressions for which the agency has been outbid: 20% to bidder(s) in the financial industry, 30% to bidder(s) in the travel industry, 10% to bidder(s) in the consumer packaged goods (CPG) industry, 20% to bidder(s) in the apparel industry, etc. If the category/industry of the client bidder is provided, a second level of the report/information could potentially include the actual name of the winning bidder (e.g., Reebok™) (e.g., if not limited by contractual obligations) against whom the client lost. Similarly, even if the agency wins bids, information regarding the category/industry of competing bidders (that have lost) may be useful.

Bidding Landscape Information Privacy

In addition to the above, embodiments of the invention may permit a particular entity to withhold/restrict certain information from being included in the competitive landscape report (referred to as “stealth mode” or “landscape privacy”). For example, an entity (e.g., client/agency) may have the ability (e.g., for a service fee) to hide its bids, name, category, etc. from being included in any report provided to another bidder/competitor (e.g., either the winning bidder and/or the losing bidder).

As another exemplary use case, suppose out of 20 million available impressions, the campaign of client 1 paying for this competitive landscape reporting is attempting to target 200,000 of them. If the campaign was only successful for 50,000 impressions, client 1 may desire information regarding the reason for such a failure. If 100,000 of the remaining impressions client 1 was unable to get were bought by a competitor, client 2, and the competitor has actually signed up for landscape privacy services, then information regarding the category/industry/client 2 name that successfully outbid the original client 1 will not be provided to the original client 1. Impressions from such winning client 2 campaigns may be grouped together in a special bucket called Private. In this case, the only competitive bid landscape information that will be available to client 1 will be from other winners who have not opted for privacy.

Neutralizer Campaign

One or more embodiments of the invention may provide what is referred to as a neutralizer campaign, or real time conquesting. In a neutralizer campaign, advertisers/agencies are permitted to define a campaign (e.g., for a fee) that will conquest impressions being sought after by a specific named set of competitors or category/industry of competitors. A neutralizer campaign includes a first entity establishing a first set of bidding parameters for acquiring advertisement impressions. In addition, the neutralizer campaign will specify that if a certain number of impressions are not acquired, due to bids being lost to a specifically named set of competitors, and/or bids being lost to an entity in a particular category/industry (e.g., the same industry as the first entity), a second set of bidding parameters may be utilized. Such a second set of parameters may merely increase the maximum bid amount, may expand the desired demographics, or may change any other parameter that a user can specify when designing a bid, and may work within the confines of a specific grade of inventory quality.

Additional embodiments may place a limit (i.e., a maximum number) on the number of neutralizer campaigns that may be implemented. Such a limit serves to prevent a bidding entity from utilizing multiple neutralizer campaigns as a mechanism for discovering the bidding practices/strategy/pricing of particular competitors.

As an example of a neutralizer campaign, a first entity may configure bidding parameters of a maximum bid of $15 for a narrow set of impressions as long as the impressions are not lost to a second bidding entity in the same industry/category as the first entity. The neutralizer campaign may further specify that if the first entity is going to lose the bid to a competitor in the same/similar industry, a maximum bid of $25 may be utilized. Accordingly, a system configured with a neutralizer campaign will slowly increment the bidding amount until reaching the maximum. For example, suppose the first entity has a maximum bidding amount of $25 and the current bid (by a competing entity) is $17. In such a secondary auction, the first entity may bid $17.01. If such an amount is successful, the impression will be acquired below the first entity's maximum. Bid amounts may be increased up to the maximum during each impression's auction process, or as an average across a day or a month, or any other rolling-window or cumulative time period. In addition, the bid campaign could specify the incremental bid amount (e.g., instead of $0.01, bidding increments of $0.02, $0.03, $1.00, etc. may be specified). With such a neutralizer campaign, the first entity is likely to be successful in overbidding competitors.

If two competitors both utilize neutralizer campaigns, each competitor may have a ceiling (i.e., a maximum bid to be used against competitors in the same/similar industry) and the highest ceiling will acquire the impression. If the same ceiling/maximum is used for both competitors, a particular impression may be awarded on a random basis or based on the max CPM achieved in a rolling-window or cumulative time period.

Varying service charges may be established for a neutralizer campaign. In one or more embodiments, a service fee may be charged to define the neutralizer campaign. Additionally (or as an alternative), a service fee may be incurred when the neutralizer campaign is actually utilized. In another embodiment (in addition or as an alternative to the above fee arrangements), a service fee may only be incurred upon a successful neutralization campaign (i.e., when an impression is acquired).

### Bid Landscape Lookup Data

To enable the bidding landscape information, bidding landscape information privacy, and the neutralizer campaign, embodiments of the invention may utilize various types of look-up data (e.g., stored in a database that may be queried). The look-up data may include CPM data, a privacy service fee, a reporting service fee, and a client's competitive set of other clients and/or their industry categorization.

The CPM data may provide a bucket at a “Country-format-devicetype” level that carries increment values (in CPM). It is used to properly format outbound reports to paying clients. For example, the following Country-format-devicetype levels may have the values specified:
US-Display-PC increment would be USD 0.10
US-Video-CTV increment would be USD 0.50
DK-Display-PC increment would be DKK 0.50
   This will allow bid landscape reports to have just enough granularity (not too broad, and not too detailed) based on the prevailing prices for different types of inventory in different countries.

The privacy service cost data may be used to determine the cost and whether a client has opted for stealth mode (as described above). A public/private flag at the client level (and/or a bidder level) may indicate the desired privacy setting. The flag may also create a service cost entry for provider cost and cost payee records/tables (i.e., the cost associated with a privacy option). In an exemplary embodiment, if the flag=1 (meaning public is O.K, which may be the default value), the client of a campaign (e.g., identified by a campaign ID in a data table) is ok having all bid landscape data for all its campaigns public. If the flag=0, data will be made private for all reporting purposes. In this regard, client's bids may still be aggregated, but both the client category and the client may be categorized as “private”. The cost value can be different by client and may be used in a maximum bid reduction part of second price auction logic.

The reporting service cost may be a cost associated with requesting bid landscape data. The reporting service cost data may include a client level flag (which may also create a service cost entry for provider cost and cost payee records/tables). The reporting service cost may not be delivered to the bidder level. Further, the cost value may be different by client and may be used in a maximum bid reduction part of second price auction logic.

The client (also referred to as “brand”) competitive set identifies competitors of a given client and stores the data necessary for a neutralizer campaign. For a specific bid manager/client account, a user interface permits the client to setup/establish/define one or more lists of other client identifiers that are considered competition. Thereafter, in a bid manager user interface, next to each maximum bid, the user may enter:
i. a second (higher) maximum bid value;
ii. a target competitor (e.g., selection from a list of the client identifiers [e.g., via a drop down]); and
iii. a specific monetary budget for the neutralizer campaign.

### Neutralizer Logical Flow

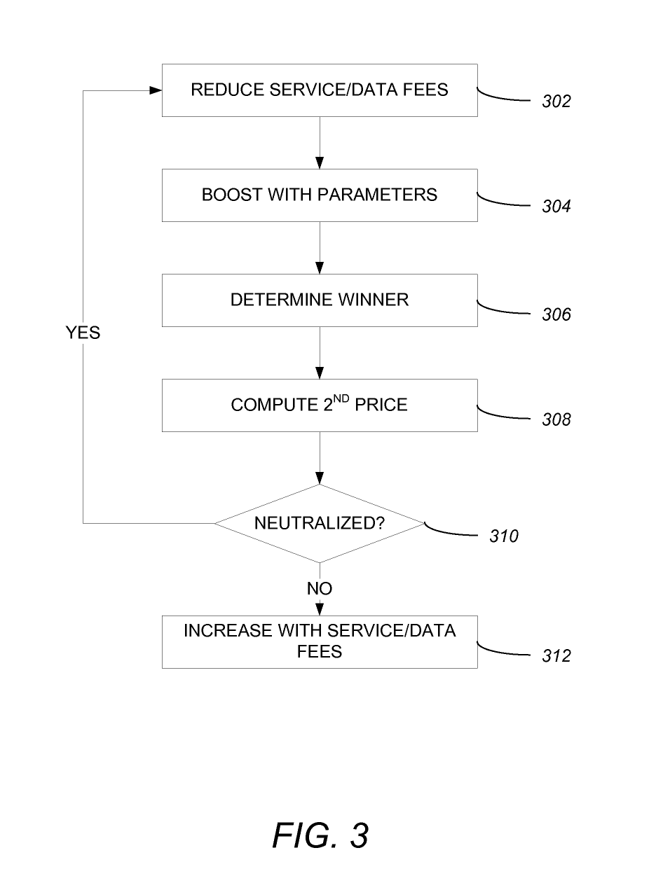

FIG. 3 illustrates the logical flow for an exemplary runtime execution of a neutralizer campaign in accordance with one or more embodiments of the invention. As used herein, the runtime logic may also be referred to as recursive challenging. Each of the steps of FIG. 3 may be performed on/by an advertising exchange system utilized for bidding for an advertising impression in a computer system.

As an overview, in each round, a determination is made regarding who's the winner (reducing service/data fees at step 302, boosting with parameters at step 304, determining the winner at step 306, and computing the second price at step 308). A determination is made at step 310 regarding whether there's a neutralizing challenger. If there is a neutralizing challenger, the winner is recursively determined (by repeating steps 302-310 until a winner is determined). Once there is no longer a challenger, the service/data fees are added back to determine how much the client is to be charged.

Details regarding each of the above steps follows.

Examples of the service/data fees (that are reduced and added back in at steps 302 and 312) include charges to the advertiser for using the Bid Manager platform, or for using a specific set of data for targeting purposes, or for delivering a rich media or verification service. All of these fees may be fixed CPM or variable revshare.

The step 304 of boosting with parameters is to allow the seller of inventory to have finer control over which advertiser, category of advertisers, buyer, etc. they consider strategic or important, and thus which they would prioritize over others. These parameters only affect the win determination and not the price paid by the winner. Thus, at step 304, the system/user defines a first maximum bid price (that may/may not include an inventory grade) and identifies a set of entities (e.g., specifically named entities, a category/industry of entities, competitors, etc.) that the advertiser would like to target. In addition, step 304 may also include the system/user defining a second maximum bid price (that is higher than the first maximum bid price) that is to be used if an advertisement auction is being lost to the identified set of entities. Such information may be stored in a queriable table.

The winner is always determined (at step 306) as the highest CPM post the above two steps.

Step 308 for the computation of the 2^{nd} price to charge the advertiser involves finding the second highest CPM value, and adding an incremental amount to it (e.g. $0.01). This ensures that advertisers bid the true maximum price they're willing to pay for an impression, knowing full well they will only pay just above what their best (but losing) competitor had bid. In other words, at this stage, the bidding continues until one winner emerges (e.g., the maximum first bid price has been exceeded by the bid price specified by the winning bidder.

At step 310, a determination is made regarding whether a neutralizer campaign should be applied. In other words, if the winning bidder is in the identified set of entities, then the neutralizing campaign process begins. During the neutralizer campaign, the second maximum bid price is now used for the particular advertisement auction.

Step 312 of increasing with service and data fees is the last step where once the final 2^{nd} price auction closes, and there are no more neutralizer campaigns, and thus the recursive challenging cycle is over, the fees that were taken out are added back in. This ensures that the advertiser pays not just for the media, but also the ancillary costs of having used a data provider's data, or a service provider's services (verification, rich media, etc.).

In addition, once the auction is complete (or during the auction), information may be provided to the bidding entities. For example, competitive landscape information that may include identification of a category or industry of an entity that wins the advertisement auction may be provided to one or more of the participating (or non-participating) parties (including bidding entities, publisher, etc.). Alternatively, if the winning entity has configured the bidding parameters to ensure a privacy of the entity's identification, the competitive landscape information may not include an identification of the winning entity, and/or a category/industry of the winning entity. Further, based on an identification of the category, suggested purchasing details (e.g., for a guaranteed and fixed-price purchase of the impression) may be provided to relevant/requesting parties.

The following example shows how multiple challenges can happen for the same impression (e.g., of Grade A) (assuming no service/data fees in the example) based on the logical flow of FIG. 3.

Three parties (X, Y, and Z) each establish bidding campaigns based on their respective budgets as follows:

X ($1M budget)

| | Normal Max | Neutralizer | | |
|---|---|---|---|---|
| Grade | Bid | Max Bid | Type | Incumbents |
| A | 10 | 35 | Imp | Y, Z |
| B | 5 | 11 | 7-day MA | Y, Z |
| C | 1 | 5 | Imp | Y, Z |

Y ($7M budget)

| | Normal Max | Neutralizer | | |
|---|---|---|---|---|
| Grade | Bid | Max Bid | Type | Incumbents |
| A | 20 | 32 | Imp | X, Z |

Z ($10M budget)

| | Normal Max | Neutralizer | | |
|---|---|---|---|---|
| Grade | Bid | Max Bid | Type | Incumbents |
| A | 30 | 39 | Imp | X, Y |

As described above, in each round, the service/data fees are reduced at step 302, parameters are boosted at step 304, a winner is determined at step 306, and the second price (i.e., the CPM price for the winner) is computed at step 308. Thereafter the service/data fees are increased/recomputed at step 312.

In round 1, Y and Z (the two highest normal bids) bid against each other where Z wins to pay $20.01 CPM;

In round 2, X challenges with a neutralizer bid of $35 CPM, and Y challenges with a neutralizer bid of $32 CPM. Thus, X wins the closing at $32.01 CPM;

In round 3, Z challenges with a neutralizer bid of $39 CPM, and wins closing at $35.01 CPM;

Thereafter, there are no neutralizers and the process is complete.

Two different types of neutralizations may be defined: per impression; and per x-day rolling window (moving average).

In a per impression neutralization type, the campaign is conducted on a per impression basis. For example, the $35 CPM max neutralizer bid is for each and every impression separately, and the runtime logic will not bid higher than the $35.

In a per x-day rolling window, the value of x is a system parameter (can be seven [7] days). A second system parameter is defined to control the maximum percentage above the neutralizer bid that the logic will bid while ensuring that the moving average stays below the stated figure. In other words, the second parameter defines a max % increase above the max neutralizer bid if the x-day rolling window average allows it. This second parameter is to ensure that huge bids are not generated if the bidding entity has already bid and won well below the maximum (and thus has built up a reserve). As an example, assume the maximum percentage parameter is 50%. If the maximum bid is $10 CPM for a 7-day rolling window, and 999 bids so far this week are won at $8 CPM, this means for the next impression, a bid may be submitted all the way to (10−8)*999=$1,998 CPM (which exceeds the expected bounds). Thus, the max bid is established at 10*(1+50%)=$15 CPM (to stop any bidding race with an exorbitant pricing structure).

### Reporting/Auditing

The various embodiments described above enable an advertiser to obtain information about the bidding landscape (e.g., both with and without the use of a neutralizer campaign). Such information may be provided in various reports/audit trails.

Reports may include a breakdown of statistics/information that may include one or more of the following:
impressions won;
impressions lost;
impressions won due to a neutralizer campaign;
impressions lost due to a neutralizer campaign (i.e., of a competitor);
impressions lost despite use of a neutralizer campaign (e.g. may be lost to a competitor's neutralizer, or to general competition due to client's neutralizer max bid being too low);
costs associated with each of the above;
percentages/charts depicting one or more of the above;
etc.

As an example, if there are 10 million impressions, a report may include a breakdown of the winning category of the impressions that were lost to another bidder. Similarly, a report may indicate which portion of the impressions (e.g., 1 million impressions) were acquired as a direct result of a neutralizer campaign (and the associated cost per mille [CPM] [also referred to as cost per thousand]). The report may provide information regarding the pricing paid (e.g., CPM) for each of the impressions.

Embodiments of the invention may also prevent/prohibit the viewing of a report in certain circumstances. For example, if a neutralizer campaign is directed towards a single entity/competitor, a report reflecting how many impressions were won/lost (e.g., and respective prices) may not be viewable by the bidder. Alternatively, if a neutralizer campaign is directed towards two or more (or some other specific number) entities/competitors, win/loss and pricing statistics may be viewable. Such viewing prohibitions may be utilized based on contractual obligations between the parties and/or to prevent a bidder from discovering the bidding practices of a (specific) competitor.

To enable the reporting capability, a table/database may be populated with information that can be queried and/or retrieved for display/printing. As an example, for each day, for each network, for each auction, for each eligible bid manager order of a specific client category, whether it won or lost the auction, an SQL-queriable table may be defined and loaded. Each auction may generate multiple rows in such a table.

Table A illustrates the defined fields of an exemplary queriable table that may be instantiated with bid landscape information in accordance with one or more embodiments of the invention.

TABLE A

| # | Column | Description |
|---|---|---|
| 1 | Date | |
| 2 | Hour | This is to allow for day reporting by timezone |
| | | bounded days. |
| 3 | Country_Id | Integer value for each country supported: US, UK, |
| | | FR, etc. |
| 4 | Format_Id | Display, Video and Audio. |
| 5 | DeviceType_Id | PC, Mobile, Tablet, Connected TV. |
| 6 | Campaign_Id | Ad server Campaign Id of Bid Manager campaign |
| | | that won or lost. Whether this data is public or |
| | | private is a lookup. |
| 7 | Win | 1 if Campaign_Id has won, 0 if it has lost. |
| 8 | Neutralizer | 1 if Campaign_Id won while being in Neutralizer |
| | | mode. 0 if Campaign_Id lost while another |
| | | campaign was in Neutralizer mode. |
| 9 | Location_Id | Ad server Location Id where imp came from. |
| 10 | Winner_Client_Id | Ad server Client Id of winner of this auction. |
| 11 | Winner_Category_Id | Ad server Category of Client Id that won this |
| | | auction. |
| 12 | CPM_Bucket_1st_price | For US-Display-PC, buckets could be $0.90-$0.99, |
| | | or $1.20-$1.29. This relates to the 1st |
| | | price/max bid (not the closing price of auction) of |
| | | the winner falling in that bucket. |
| 13 | Count_1st_price | Count, group by for items 1-12. |
| 14 | CPM_Bucket_2nd_price | Relates to the closing price of auction falling in |
| | | this bucket. |
| 15 | Count_2nd_price | Count, group by for items 1-12. |

In addition to the above, embodiments of the invention may provide a report (e.g., to publishers) indicating the category of clients buying its impressions. Based on such a report, embodiments of the invention may provide support in the form of suggesting direct sale campaigns and private marketplaces. For example, based on the exposure of clients/categories of clients buying impressions, embodiments of the invention may suggest direct guaranteed and fixed-price deals. In other words, once the category/industry is known (along with the successful campaign information including pricing), an application may utilize such information to propose (to a publisher) an alternate impression sale process. The publisher may be presented with an option for a private marketplace where the publisher invites specific agencies/clients to bid in a fixed price manner. Such a private marketplace enables a publisher to guarantee a set price for particular impressions versus a variable price that is not guaranteed. Alternatively, an application may suggest a direct sale for each impression for particular clients/industries along with suggested pricing.

To enable the private marketplace/direct sale recommendations, a product entity may be defined as a child of a client in order to categorize competition in a more granular fashion. Each fixed price guaranteed booking, and each bid manager order, may be categorized as a specific product. For example, a Toyota campaign can be categorized as Camry, Highlander, Prius, etc. as each has its own set of competitors. Further, all real-time bids may be categorized at the client level only. Various preventive measures may also be in place to ensure that a bid manager advertiser does not go into a bidding war against itself. Once defined, specific products and successful campaigns may be used to establish pricing as well as clients that are likely to bid on an impression.

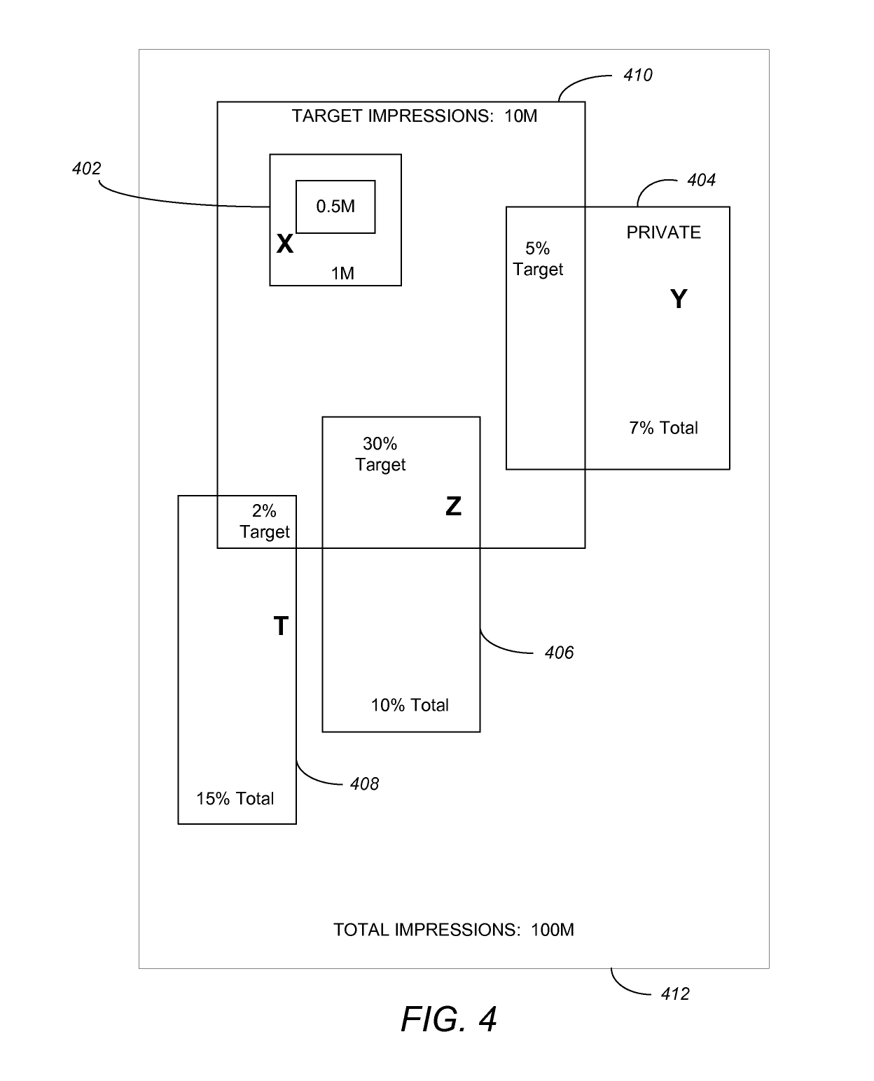

Further to the above, embodiments of the invention may provide two share of voice (SOV) reports, each either by advertiser or by advertising category. FIG. 4 illustrates a Venn-like diagram illustrating the target and total impressions for various clients in accordance with one or more embodiments of the invention. The clients competing for impressions are X 402, Y, 404, Z 406, and T 408. The total number of impressions that fall into client X's target, shown as 410, is 10M impressions out of a total 412 of 100M impressions. But Client X 402 is able to purchase only 0.5 M impressions (using X's budget of 1M), due to bidding low or competitive forces. Clients X 402, Z 406, and T 408 could each have a certain percent as “Private,” since another client (i.e., client Y 404) has opted to hide his/her purchases (indicated by the “Private” notation). The following two SOV reports may provide:

(1) SOV on that day within a client's target (the type of users they were intending to reach (e.g., males, 18-34):

Target SOV

| | |
|---|---|
| X | 5% |
| Z | 30% |
| T | 2% |
| Named Other | 7% |
| . . . | . . . |
| Named Other | 10% |
| Private | 5% |
| | 100% |

(2) SOV on that day within the entire serving on the exchange:

Total SOV

| | |
|---|---|
| X | 0.5% |
| Z | 10% |
| T | 15% |
| Named Other | 8% |
| . . . | . . . |
| Named Other | 10% |
| Private | 7% |
| | 100% |

Accordingly, reports may be shown graphically as illustrated in FIG. 4 or may be shown in a table form as shown above.

The results of the target 410 and total 412 SOV may be used to automate conquesting in accordance with the following table:

| | Low | High |
|---|---|---|
| Budget | Increase Budget | Decrease |
| Capped | | Budget |
| | | and/or Bids |
| Budget | Increase Bids | Decrease |
| Not Capped | | Bids |

As an example, clients 402-408 may first be allowed to enter target and total SOV values (e.g., 30% and 4% respectively). Depending on how the client has set the target and total SOV values, the following may rules may apply (per the table above):
If the actual target or total SOV is lower than the entered value, and the budget is capped, the client needs to increase the budget (upper left box of the table above);
If the actual target or total SOV is lower than the entered value, and the budget is uncapped, the client needs to increase bids (the lower left box of the table above);
If the actual target or total SOV is higher than the entered value, and the budget is capped, the client needs to decrease the budget and/or bid (upper right box of the table above); and
If the actual target or total SOV is lower than the entered value, and the budget is uncapped, the client needs to decrease the bid (the lower right box of the table above).

In automation, the above logic can be executed by the system and the output recommendation may be emailed (e.g., as an alert), exposed in the user interface for the agency user to act upon, or simply used within the system to change the bids/budgets (which would require more settings to allow clients to have the control needed).

### CONCLUSION

This concludes the description of the preferred embodiment of the invention.

The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for acquiring advertisement impressions through an advertisement auction, comprising:
defining a first maximum bid price to acquire an impression;
identifying an entity set comprising one or more entities;
defining a second maximum bid price to acquire the impression, wherein the second maximum bid price is higher than the first maximum bid price;
bidding, in the advertisement auction, for the impression using the first maximum bid price;
determining, that the advertisement auction for the impression is being lost to the identified entity set; and
based on the determining, bidding, in the advertisement auction, for the impression using the second maximum bid price.

2. The computer-implemented method of claim 1, wherein the first maximum bid price specifies an inventory grade.

3. The computer-implemented method of claim 1, wherein the advertisement auction comprises a second price auction.

4. The computer-implemented method of claim 1, wherein the set comprises one or more competitors.

5. The computer-implemented method of claim 1, wherein the set comprises one or more specifically named entities.

6. The computer-implemented method of claim 1, wherein the set comprises a category or industry.

7. The computer-implemented method of claim 1, wherein the first maximum bid price, the second maximum bid price, and the entity set is stored in a queriable table.

8. The computer-implemented method of claim 1, further comprising:
providing competitive landscape information that comprises identification of a category or industry of an entity that wins the advertisement auction for the impression.

9. The computer-implemented method of claim 1, further comprising:
providing competitive landscape information wherein the competitive landscape information does not include an identification of a category or industry of a winning entity of the advertisement auction, wherein the winning entity has configured bidding parameters to ensure a privacy of the identification.

10. The computer-implemented method of claim 1, further comprising:
providing a publisher of the impression with an identification of a category of clients that successfully acquired the impression.

11. The computer-implemented method of claim 10, further comprising:
based on an identification of the category, providing suggested purchasing details for a guaranteed and fixed-price purchase of the impression.

12. An advertising exchange system for bidding for an advertising impression in computer system comprising:
(a) a server computer having a processor and memory;
(b) an advertising exchange application executed by the processor on the server computer, wherein the advertising exchange application is configured to:
(1) define a first maximum bid price to acquire an impression;
(2) identify an entity set comprising one or more entities;
(3) define a second maximum bid price to acquire the impression, wherein the second maximum bid price is higher than the first maximum bid price;
(4) bid, in the advertisement auction, for the impression using the first maximum bid price;
(5) determine, that the advertisement auction for the impression is being lost to the identified entity set; and
(6) based on the determining, bid, in the advertisement auction, for the impression using the second maximum bid price.

13. The advertising exchange system of claim 12, wherein the first maximum bid price specifies an inventory grade.

14. The advertising exchange system of claim 12, wherein the advertisement auction comprises a second price auction.

15. The advertising exchange system of claim 12, wherein the set comprises one or more competitors.

16. The advertising exchange system of claim 12, wherein the set comprises one or more specifically named entities.

17. The advertising exchange system of claim 12, wherein the set comprises a category or industry.

18. The advertising exchange system of claim 12, wherein the first maximum bid price, the second maximum bid price, and the entity set is stored in a queriable table.

19. The advertising exchange system of claim 12, wherein the advertising exchange application is further configured to:
provide competitive landscape information that comprises identification of a category or industry of an entity that wins the advertisement auction for the impression.

20. The advertising exchange system of claim 12, wherein the advertising exchange application is further configured to:
provide competitive landscape information wherein the competitive landscape information does not include an identification of a category or industry of a winning entity of the advertisement auction, wherein the winning entity has configured bidding parameters to ensure a privacy of the identification.

21. The advertising exchange system of claim 12, wherein the advertising exchange application is further configured to:
provide a publisher of the impression with an identification of a category of clients that successfully acquired the impression.

22. The advertising exchange system of claim 21, wherein the advertising exchange application is further configured to:
based on an identification of the category, provide suggested purchasing details for a guaranteed and fixed-price purchase of the impression.
